(19) United States
(12) Patent Application Publication
(10) Pub. No.: US 2015/0183692 A1
(43) Pub. Date: Jul. 2, 2015

(54) METHOD OF PREPARING HIGH POROSITY CERAMIC MATERIAL

(71) Applicant: Dow Global Technologies LLC, Midland, MI (US)

(72) Inventors: Michael T. Malanga, Midland, MI (US); Janet M. Goss, Saginaw, MI (US); Gregoire A. Gaudry, Vezenobres (FR)

(21) Appl. No.: 14/421,464

(22) PCT Filed: Mar. 11, 2013
(86) PCT No.: PCT/US2013/030191

§ 371 Date: Feb. 13, 2015

(30) Foreign Application Priority Data
Aug. 16, 2012 (US) 61/683947

(51) Int. Cl. C04B 38/06; C04B 35/185

(52) U.S. Cl. CPC C04B 38/06; C04B 35/185; C04B 2235/48; C04B 2235/425; C04B 2235/3463

(57) ABSTRACT

Contacting a mixture of two or more porogens with a mixture used to prepare a ceramic body; wherein one of the porogens has a significantly different chemical property from that of at least one of the other porogens. The ceramic material is dried, and calcinated. The ceramic material must withstand the heat from the drying process and the calcining to become a sintered: (ceramic) body. By increasing the overall stability of the ceramic material the product yield is about 90% or greater.

### FIELD OF THE INVENTION

The invention relates generally to a process of preparing a porous ceramic body.

### BACKGROUND OF THE INVENTION

Diesel and gasoline engines emit soot particles, very fine particles of carbon and soluble organics as well as typical harmful engine exhaust gases (i.e., HC, CO and NOx). Regulations have been enacted curbing the amount of soot permitted to be emitted. To comply with regulatory standards, particulate filters are used in conjunction with exhaust systems for engines and particularly exhaust systems for diesel engines to remove contaminants from the exhaust stream. In addition to the regulations on soot limits, particulate filters must meet stringent requirements such as: the filter is expected to have a sufficient porosity (e.g., generally greater than 55 percent porosity) while still retaining most of the emitted micrometer sized diesel particulates (e.g., generally greater than 90 percent capture of the emitted particulates). The filter is expected to be permeable enough so that excessive back pressure does not occur too quickly as soot builds up on it, and it is expected that the particulate filter may be loaded with a great amount of soot before being regenerated. The filter is expected to withstand the corrosive exhaust environment for long periods of time and thermal cycling from the burning off of the soot entrapped in the filter (i.e., regeneration) over thousands of cycles. Based on these stringent criteria, ceramic filters are the choice of material to develop diesel particulate filters.

Porous ceramic materials have found use for filtering particulates from fluid streams. Porosity can be modified through the use of porogens in the preparation of the ceramic bodies. Porogens are organic materials that are included in mixtures used to form the ceramic bodies which are burned out in a debindering step leaving pores in the formed ceramic bodies behind. One such ceramic material is silicate-based ceramics as disclosed in PCT WO 2009/019305 A2. Other possible ceramic materials are cordierite, as disclosed in U.S. Pat. No. 7,648,548 B2, or an oxide-based ceramic material such as aluminum titanate as disclosed in U.S. Pat. No. 7,744,670 B2, both incorporated herein by reference. Another useful material is acicular mullite because it exhibits high strength and high resistance to thermal shock, while maintaining high porosity so that the back pressure does not quickly increase. Pyzik et al., “Formation mechanism and microstructure development in acicular mullite ceramics fabricated by controlled decomposition of fluorotopaz,” available at www.science direct.com, or Journal of the European Ceramic Society 28 (2008) 383-391, May 3, 2007, discloses a method of forming acicular mullite ceramics, incorporated by reference herein.

Porogens may be created from any carbon based additive; examples include graphite, polymer beads and fibers, as disclosed in WO 2009/019305 A2; potato starch, elemental carbon, graphite, cellulose, and flour as disclosed in U.S. Pat. No. 7,648,548 B2; canna starch, sago palm starch, and green mung bean starch, as disclosed in U.S. Pat. No. 7,744,670 B2; any other starches, ground nut shells, carbon black, polymers or any combination thereof, all incorporated herein by reference. These porogens along with other organic materials and carrier liquids, such as water, are used to create a paste of the ceramic precursors that can be formed into useful objects by extrusion, injection molding, press casting or other forming methods known in the industry. Following the formation of the ceramic precurser material, a majority of the water must be removed. To remove the water the formed object of ceramic precursor material undergoes a drying process. The drying process may be performed in driers, for example, microwave or radio frequency driers. Additional drying methods include those disclosed in U.S. Pat. No. 7,648,548B2 for example hot air, steam, and dielectric drying, which can be followed by ambient air drying. Although these methods allow for quick evaporation of carrier liquid, water, they can cause the formed ceramic filters to crack resulting in an unusable product. A preferred method of drying the ceramic bodies involves the use of microwave dryers.

Following the drying process the ceramic material undergoes debindering and calcining (also called Firing and Burning or sintering). This process is used to remove all the organic additives used to make the formable paste and to strengthen the ceramic precursor for further processing. Debindering and calcining can be performed in a muffle furnace, a retort furnace, reverberatory furnace, or a shaft furnace. During debindering and calcining the ceramic precursor material is subjected to a large thermal gradient as all of the porogen and other organic additives oxidize in a short period of time. If the correct porogen and materials are used this step removes all traces of the porogen and leaves pores where the porogen once was. The large thermal gradiant produced as the porogen oxidizes can expose the ceramic precursor material to thermal stress which can cause cracking of the formed object such as the extruded honeycomb objects used in filter applications. In exposing the formed body to extreme temperature gradients as the porogens and binders are oxidizing, the body can crack. Since the desired outcome is a ceramic body with a porosity above 60% that can withstand later stresses, it is important that the body is sound from the beginning.

What is needed is a process for the preparation of porous ceramic bodies that will not weaken a porous ceramic body when it is subjected to drying, such as microwave drying, and high temperature gradients during processing, such as during debindering, operations as the formed body is converted fully to a ceramic material. What is also needed is a process that will increase the overall yield by reducing the number of bodies which crack without increasing the time needed to create a ceramic body. A more economic method for making a ceramic body is also needed. A process that can be used in existing processes and equipment is preferred, for instance can be used in microwave dryers.

### SUMMARY OF THE INVENTION

The present invention provides a way to increase the porosity in ceramic bodies such as ceramic honeycombs, while increasing the product yield throughout the drying, debindering and calcining processes and decreasing the amount of cracking of parts.

The first aspect of the invention is a process comprising: contacting a mixture of two or more porogens with a mixture used to prepare a ceramic body; wherein one of the porogens has a significantly different chemical property from at least one of the other porogens; removing the carrying fluid, such as water, from the mixture; debindering, including porogen removal by oxidation.

In one embodiment of the invention, the process may comprise the use of a mixture of two or more porogens where at least one of the porogens has a hydrophobic character and at least one of the other porogens has a hydrophilic character. In another embodiment of the invention, the process may comprise the use of a mixture of two or more porogens where at least one of the porogens has a significantly different burnout temperature than that of at least one of the other porogens. In one embodiment of the invention, the process may comprise the use of a mixture of two or more porogens having different properties as discussed hereinafter where the mixture of two or more porogens lengthens the time period for an exothermic reaction during the calcining process. In another embodiment of the invention, the process may comprise the use of a mixture of two or more porogens having different properties as discussed hereinafter where the mixture of two or more porogens reduces a ΔT to below about 120° C. and preferably below about 100° C. In one embodiment, the process may comprise the use of a mixture of two or more porogens such that when the mixture is exposed to a drying process, a reduction in cracking of the ceramic bodies results. In another embodiment of the invention, the process may comprise a mixture of two or more porogens during debindering. Debindering and calcining is performed in the presence of varying levels of oxygen (including air having normal oxygen levels) without the need to slowly increase the temperature in the kiln over an extended period of time. In another embodiment the burnout of the porogens can be performed in a low oxygen environment, for example, about 2 to 3 percent oxygen. Alternatively, the burnout of the organic carbon containing compounds can be performed at low oxygen levels and the burnout of the higher temperature burning porogens can be performed at higher oxygen levels up to pure oxygen. The burnout and related exotherm may be partially controlled using conventional means such as adjusting the temperature ramp up rates.

The use of only one porogen in the process to burn out the porogen from a ceramic body can cause cracking due to high thermal stresses. The ceramic material must not crack during the drying process or crack due to the heat generated during the debindering process. By increasing the overall stability of the ceramic precursor body during processing, the product yield is increased to 80% or greater, more preferably about 90% or greater, and most preferably about 95% or greater. Overall, this process reduces cracking of the honeycombs during the drying step and debindering, porogen oxidation and calcining step. This debindering and porogen oxidation process can be carried out over a relative short process time, preferably about 14 hours or less.

### BRIEF DESCRIPTION OF THE DRAWINGS

FIG. 1 illustrates the location where the temperature of ceramic bodies are tested during porogen burnout.

FIG. 2 shows the Δ T between the core and the edge of a ceramic body for three examples.

### DETAILED DESCRIPTION OF THE INVENTION

The following claims are hereby incorporated by reference into this written description. This application claims priority from U.S. Provisional Application Ser. No. 61/683,947 filed Aug. 16, 2012, incorporated by reference herein in its entirety. One or more means that at least one, or more than one, of the recited components may be used.

The ceramic body may be formed by any suitable process such as those known in the art, the most common being extrusion of a mixture comprised of ceramic particulates and extrusion additives and carrier liquids to make the mass plastic and to bond the particulates together. The extruded ceramic material is then typically dried of carrier liquids and heated to oxidize and remove organic additives such as lubricants, binders, porogens and surfactants (debindered). Further heating is performed to calcine the body, create new particulates that subsequently fuse together. This last step can be referred to as sintering. In many processes debindering and calcining are performed in the same apparatus at different temperatures, generally the temperature is increased, ramped up, at a controlled rate. Such methods are described by numerous patents and open literature with the following merely being a small representative sample of U.S. Pat. Nos. 4,329,162; 4,741,792; 4,001,028; 4,162,285; 3,899,326; 4,786,542; 4,837,943 and 5,538,681, all incorporated herein by reference.

The chemicals or ingredients used in the mixture to extrude a ceramic body impart the final functionality and characteristics of the finished ceramic bodies. A number of ceramics are known in the art, these include alumina, zirconia, silicon carbide, silicon nitride and aluminum nitride, silicon oxynitride and silicon carbonitride, mullite, cordierite, beta spodumene, aluminum titanate, strontium aluminum silicates, lithium aluminum silicates, mullite-cordierite composites, or mixtures thereof. Preferred porous ceramic bodies include silicon carbide, cordierite, aluminum titanate, mullite, mullite-cordierite composites or combinations thereof. The most preferred porous ceramic body is mullite or mullite-cordierite composites, and more preferably those having an acicular microstructure.

In making the ceramic compositions, precursor compounds, for example containing Al, Si, and oxygen, are mixed to form a mixture capable of forming a ceramic body. Precursor compounds that may be used are described in U.S. Pat. Nos. 5,194,154; 5,198,007; 5,173,349; 4,911,902; 5,252,272; 4,948,766 and 4,910,172. The mixture may also contain organic compounds to facilitate the shaping of the mixture (for example, binders, lubricants and dispersants, such as those described in Introduction to the Principles of Ceramic Processing, J. Reed, Wiley Interscience, 1988), incorporated herein by reference. Examples include clays, alumina powders, and silica. The precursors are generally used in Al:Si:O ratios that form the mullite ceramic when converted at high temperature. Preferred is the use of an alumina and silica precursor composition with a ratio of Al:Si between 2.8 and 4.2 and most preferred between 2.9 and 4.0.

It is desirable that the final ceramic composition contains a sufficient amount of grains to filter particulate materials from the exhaust as well as resist damage during regeneration cycles. The final ceramic composition is comprised of grains; in the form of needles, fibers, crystals, or a combination thereof. In making the ceramic body of this invention, typically a “plasticized extrudable mixture” containing the precursors described above is prepared. To achieve the desired size and distributions of grains, the grains maybe first comminuted by any suitable means such as ball/pebble milling, attrition, jet milling or the like at conditions readily determined by one of ordinary skill in the art for the particular technique. Grains of the proper size are then typically mixed with a carrier liquid to make a “plasticized mixture”.

Organic binders are often contained in the plasticized mixture. Organic binders include any known materials which render the ceramic mixture capable of being extruded. Preferably, the binders are organic materials that decompose or bum at temperatures below the temperature where in the ceramic precursors or ceramic mixture react to form ceramic bodies or parts. Among preferred binders are those described in Introduction to the Principles of Ceramic Processing, J. Reed, Wiley Interscience, 1988) incorporated herein by reference. A particularly preferred binder is methyl cellulose (such as METHOCEL™ A4M methyl cellulose, The Dow Chemical Co., Midland, Mich.). Liquid carriers include any liquid that facilitates formation of a ceramic mixture. Among preferred liquid carriers (dispersants) are those materials described in Introduction to the Principles of Ceramic Processing, J. Reed, Wiley Interscience, 1988). The carrier liquid may be, for example, water, any organic liquid, such as an alcohol, aliphatic, glycol, ketone, ether, aldehyde, ester, aromatic, alkene, alkyne, carboxylic acid, carboxylic acid chloride, amide, amine, nitrile, nitro, sulfide, sulfoxide, sulfone, organometallic or mixtures thereof. Preferably, the carrier liquid is water, an aliphatic hydrocarbon, alkene, aliphatic alcohol, glycol or a combination thereof. When an alcohol is used, it is preferably methanol, propanol, ethanol or combinations thereof. More preferably, the liquid is an alcohol, water, glycol or a combination thereof. Most preferably, the carrier liquid is water, glycol or combination thereof.

During processing of ceramic mixtures to form ceramic bodies, proper control of the drying process and the debindering process can result in significant reduction in cracking and resulting increases in productivity of the processes. By selection of two or more porogens having different properties, such as different peak burnout temperatures or level of hydrophilicity, cracking can be reduced. Hydrophilic as used herein means an affinity to polar carrier liquids, such as water. Hydrophilic materials, porogens, generally have a significant number of functional groups capable of hydrogen bonding such that the materials slow the release of polar carrier liquids during drying or heating. Hydrophobic as used herein refer to materials that have a low density of or no functional groups which have an affinity for polar carriers, such as water, such that during drying the materials easily release the polar carriers. By use of two or more porogens having different hydrophilic nature, that is one is hydrophilic and the other is hydrophobic, cracking as a result of drying can be reduced. During debindering the porogens oxidize and an exotherm is created. If the exotherm is too high, cracking may result. Generally, such exotherms result in differences in the temperature across the ceramic body during debindering, referred to herein as Δ T. Thus it is desirable to use two or more porogens having different burnout temperatures to reduce cracking. Burnout temperature as used herein means the peak exotherm temperature of a material during processing. Such peak exotherm temperatures can be determined using well known techniques, such as DSC (Differential Scanning calorimetry). In terms of reducing cracking during processing it is desirable to use two or more porogens with different hydrophilic natures, one being hydrophilic and the other being hydrophobic, or having different burnout temperatures. In some preferred embodiments, the two or more porogens have different hydrophilic nature and different burnout temperatures. In some preferred embodiments one or more of the porogens are hydrophilic and burnout at relatively low burnout temperatures and one of more other porogens are hydrophobic in nature and exhibit relatively high burnout temperature. As used with respect to burnout temperature the term relatively refers to the fact that a chosen set of porogens exhibit different burnout temperatures relative to one another, some are lower and some are higher.

To increase the number of pores in the plasticized mixture, porogens are added. Porogens are materials specifically added to create voids in the “plasticized mixture” after being burned out, for example. Typically these may comprise any particulates that decompose, combust to volatile organics, water and CO₂, evaporate or in some way volatilize. away during debindering to leave a void. The resulting ceramic body should be sufficiently porous, for example, at least 50% porous, to be useful for the intended uses, such as a diesel particulate filter, as previously described. However, the porosity must not be so great that for example the material strength is so low that the filter breaks or fails to capture sufficient particulate matter. The porosity of the ceramic body after calcining is preferably about 56% or greater and preferably about 85% or less.

Porogens may be created from any particulate matter that burns out of the structure at temperatures below temperatures at which the materials begin to partially bond, preferred particulate matter are carbon based materials, and for the purpose of this invention can be divided into general categories. Debindering and porogen burnout is evidenced by the evolution of CO₂ during the process and by exotherm peaks in a DSC scan. The first category is organic carbon containing compounds or products that are preferably hydrophilic; this group is comprised of any organic carbon product which can be turned into a powder and which can burnout during calcining and remain stable under drying conditions, which preferably contain hydrogen and other labile substituents that are capable of hydrogen bonding with polar carrier fluids. Hydrophobic porogens are materials that have a low density of or no substituents that are capable of hydrogen bonding with polar carrier liquids, and include polymers having a low density of such groups and carbon based materials that have low amounts of hydrogen and other labile substituents. Exemplary organic carbon products, hydrophilic porogens, include carbon based particulate matter having hydrogen and/or labile substituents and include ground nut shells, flours, cellulose, starches, or any combination thereof. More preferably the organic carbon product is a starch. Exemplary starches are cornstarch, potato starch, canna starch, sago palm starch, green mung bean starch, or any combination thereof. Most preferably the organic carbon product used is cornstarch. Exemplary hydrophobic materials include hydrophobic polymers and carbon based particulates that contain few or no hydrophilic groups. Hydrophobic carbon based particles include graphite, graphene, carbon black, elemental carbon, or any combination thereof. More preferably the hydrophobic particulate carbon product is graphite, carbon black, or any combination thereof, and most preferably the hydrophobic carbon product is graphite. Examples of hydrophobic polymers include cellulosic polymers, modified or unmodified cellulose and the like which have a low concentration of functional groups capable of hydrogen bonding.

In some embodiments one class of porogens are Low Temperature Burning materials. Low temperature burning materials (LTB) (that is substituents that oxidize or bum out at relatively low temperature compared to the temperature at which the materials begin to partially bond), generally exhibit a burnout temperature from about 200° C. to about 600° C., more preferably from about 300° C. to about 500° C., and most preferably from about 350° C. to about 450° C. Exemplary LTB materials are organic carbon products, including carbon based particulate matter having hydrogen and/or labile substituents and include ground nut shells, flours, cellulose, starches, or any combination thereof. More preferably the LTB is a starch. Exemplary starches are cornstarch, potato starch, canna starch, sago palm starch, green mung bean starch, or any combination thereof. Most preferably the LTB used is cornstarch. The second category is high temperature burning (HTB) carbon products. HTB carbon products are carbon based particulates that burn out at temperatures above the temperatures that the low temperature carbon products burn out. HTB materials exhibit a burnout temperature of about 500° C. to about 900° C., more preferably about 650° C. to about 850 ° C. It is desirable to select the difference in the burnout temperature of the LTB material and the HTB carbon products such that the ΔT during debindering is about 120° C. or less and more preferably 100° C. or less. Preferably the difference is burnout temperature is about 200° C. or greater, more preferably about 300° C. or greater and most preferably 350° C. or greater. HTB carbon products are comprised of any particle containing carbon and a low concentration of or no hydrogen or labile substituents. Examples of HTB carbon products include graphite, graphene, carbon black, elemental carbon, or any combination thereof. More preferably the HTB carbon product is graphite, carbon black, or any combination thereof, and most preferably graphite. It is preferable that the porogens be selected such that the wet ceramic bodies can be dried in microwave ovens. The HTB carbon products can introduce conductivity into the wet ceramic bodies when utilized above their percolation concentration. Percolation threshold concentration is that concentration that results in rendering the mixture mainly conductive. The HTB carbon products are preferably utilized in a concentration that is less than the percolation threshold concentration because such materials can be dried more easily in microwave dryers, above the percolation threshold concentration microwave driers cannot be utilized without the risk of sparking, arcing, locally burning the ceramic bodies or starting a fire in the ceramic bodies.

In adding porogens to the extruded plasticized mixture it is preferable to use at least two different porogens with different burnout temperatures, a low temperature burnout porogen and a high temperature burnout temperature porogen. Burnout temperature is the temperature at which a porogen undergoes an exothermic reaction and oxidizes completely leaving a low amount or no trace of the porogen behind. Low amount of porogen means about 1 percent by weight or less, more preferably 0.1 percent by weight or less and most preferably 0.01 percent by weight or less. Burnout of ceramic bodies takes place over a range of temperatures. Generally the peak exotherm occurs in a narrow range which can be referred to as the burnout temperature. More preferred is the addition of two or more porogens with different burnout temperature ranges and peak burnout temperatures, one being one or more LTB carbon products and the other being one or more HTB carbon products. Preferably at least one is hydrophobic and the other is hydrophilic. Most preferred is the addition of two porogens where one from is corn starch and the other is graphite. The porogens are added to the plasticized mixture at a ratio such that the ΔT within the ceramic bodies, such as from the edge of a part to the core of a part, during the burn out of these porogens is 120° C. or less. The preferred ratio of hydrophilic or low temperature burnout organic carbon products to hydrophobic or HTB carbon products is about 1:1 or greater, more preferably about 2:1 or greater, even more preferably about 3:1 or greater, and most preferably about 4:1 or greater, and preferably about 6:1 or less.

The plasticized mixture is then shaped into a porous shape (ceramic material) by any suitable method, such as those known in the art. Examples include injection molding, extrusion, isostatic pressing, slip casting, roll compaction and tape casting. Each of these is described in more detail in Introduction to the Principles of Ceramic Processing, J. Reed, Chapters 20 and 21, Wiley Interscience, 1988. The ceramic material is then ready to be dried.

The extruded mixture is then dried. Any process which assists in removing the liquid carrier from the wet ceramic material may be utilized to dry the ceramic material. The extruded mixture is preferably dried in ovens. Among preferred ovens useful in the invention are convection, infrared, microwave, radio frequency ovens and the like. In a more preferred embodiment a microwave oven is used. The wet ceramic material may or may not be placed on a carrier structure that may be placed in an oven for a sufficient time for the liquid carrier to be substantially removed from the ceramic material and then removed from the oven. The wet ceramic material on a carrier structure can be manually placed in and removed from the oven. Alternatively the wet ceramic material can be automatically introduced, moved through and removed from an oven. Any automatic means for introducing a part into and removing a part from an oven may be utilized. Such means are well known in the art. In a preferred embodiment, the wet ceramic material on a carrier structure is placed on a conveyor and passed through one or more ovens on the conveyor. The residence time of a wet ceramic material on a carrier structure in the one or more ovens is chosen such that under the conditions of the one or more ovens substantially all of the liquid carrier (in most cases this is water) is removed. The residence time is dependent upon all of the other conditions, the size of the wet ceramic material structure and the amount of liquid carrier to be removed. The temperature that the wet ceramic material on a carrier structure is exposed to in the one or more ovens is chosen to facilitate the removal of the liquid carrier from the wet ceramic material. Preferably the temperature is above the boiling point of the liquid carrier and below the softening temperature of material from which the carrier structure is fabricated and the temperature at which any of the ceramic precursors decompose. Preferably, the temperature that the wet ceramic material on a carrier structure is exposed to in the oven is about 60° C. or greater, more preferably about 80° C. or greater and most preferably about 100° C. or greater. Preferably, the temperature that the wet ceramic material on a carrier structure is exposed to in the oven is about 120° C. or less and most preferably about 110° C. or less. The wet ceramic material in the oven is preferably contacted with a drying fluid or a vacuum is applied to the oven to facilitate removal of liquid carrier from the wet ceramic material. Preferably, the wet ceramic material is contacted with a drying fluid. In the embodiment, wherein the wet ceramic material is shaped as the precursor to a flow through filter, wherein the flow passages in the wet ceramic material have not been plugged at one end, it is preferable to flow the drying fluid through the flow passages of the wet ceramic material. This is facilitated by directing the drying fluid to flow in the same direction as the flow passages are disposed on the carrier structure. Where the wet ceramic material has a flat planar side and the wet ceramic material is disposed on the carrier structure on its flat planar side, the flow of the drying fluid is directed to flow through the flow passages in the wet ceramic material. In the embodiment wherein the wet ceramic material on the carrier structure is passed through one or more ovens on a conveyor, wet ceramic material are disposed such that the direction of the flow passages are transverse to the direction of the conveyor and the drying fluid is passed in a direction transverse to the direction of the conveyor such that the drying fluid passes through the flow passages of the wet ceramic material. If one face of the wet ceramic material is disposed on the carrier structure, the drying fluid is directed up through the carrier structure in the direction of the wet ceramic material so that the drying fluid passes into and through the flow passages in the wet ceramic material. The drying fluid can be any fluid which enhances the removal of liquid carrier from the vicinity of the wet ceramic material. Preferably the drying fluid is a gas. Preferred gasses include air, oxygen, nitrogen, carbon dioxide, inert gasses and the like. Most preferably the drying fluid is air. After the drying fluid is contacted with the wet ceramic material it is removed from the vicinity of the wet ceramic material along with the liquid carrier entrained in the drying fluid. The flow of drying fluid is generated by any means which facilitates movement of a drying fluid such as a pump, a blower, and the like. The flow rate of the drying fluid is chosen to facilitate the removal of liquid carrier from the vicinity of the wet ceramic material. Other important parameters for drying ceramic parts may be: the frequency regimes of microwave power used (e.g., 2.45 GHz and 915 MHz), varied reflected powers at differing frequencies (from about 0 to about 100%), relative humidity that can vary from about 0 to about 100%, residence time that can vary from about 0.01 to about 10 hours in periodic oven or belt driven continuous ovens, and a maximum part temperature that can range from about 50 to about 150° C.

The drying process removes about 85% or greater, more preferably about 90% or greater, most preferably about 98% or greater and preferably about 100% or less of the carrier liquid, water, present. During the drying process the preferred combination of the porogens helps to reduce the occurrence of cracking. It is believed this is due to the hydrophobic nature of certain porogens, such as graphite, and the hydrophilic nature of the other porogens, such as cornstarch. To maintain the honeycomb structure the exposure to destructive conditions must be reduced. To reduce these conditions the hydrophilicity is lowered and the condition extremes are moderated when a hydrophobic porogen is combined with a hydrophyilic porogen since the absorbtion rate and desorption rate of polar liquids from those materials is drastically different. Cracking of honeycombs or other extruded or otherwise molded wet articles is prevented as the carrier liquid is removed from the parts in a more even manner.

In known processes a significant number of ceramic bodies are destroyed during drying due to cracking, in some cases up to 75%. Using mixed porogens results in a reduction of cracked parts to preferably about 25% or less, or more preferably about 10% or less, and most preferably about 5% or less. Similarly in known processes a significant number of ceramic bodies are destroyed during the debindering (porogen oxidation) and calcining process due to cracking, in some cases up to 50% of the ceramic bodies. The need to produce extra ceramic bodies to compensate for potential cracking leads to unnecessary additional costs. However the process in this invention can reduce these unnecessary costs.

After removal of the liquid carrier from the wet ceramic material, the ceramic material can be prepared for conversion to a ceramic body and converted to a sintered body. The ceramic material is exposed to conditions to burnout the binder and organic material (including porogens) and to form the ceramic structure. Processes to achieve this are well known in the art. The dry ceramic materials are debindered (porogens oxidized) and calcined by heating the dry ceramic material under oxidative conditions to temperatures at which organic additives, porogens, and binders are volatilized or burned away (so-called burn out conditions). The parts are further heated to temperatures at which the ceramic particles fuse or sinter together or create new particulates that subsequently fuse together. Such methods are described by numerous patents and open literature including U.S. Pat. Nos. 4,329,162; 4,471,792; 4,001,028; 4,162,285; 3,899,326; 4,786,542; 4,837,943 and 5,538,681; all incorporated herein by reference. Each of debindering (porogen oxidation) and calcination, fusing of ceramic particles together can be performed as discrete steps in different units of operation. Perferably these steps are performed in a single unit with each of the steps occurring at different temperatures. The temperature and time for each step varies depending on materials used, equipment used and process conditions.

Debindering and calcining can be carried out in different heating units. Possible heating units that may be used are elevator kilns, a muffle furnace, a retort furnace, reverberatory furnace, a shaft kiln, controlled atmosphere electric refractory kilns, or any other furnace known in the art for calcining. More preferably debindering and calcining is carried out in a controlled atmosphere electric refractory kiln

In some embodiments, it may be desirable that oxygen level within the heating unit is controlled. In the present invention the debindering, porogen oxidation and calcining may be performed in the presence of oxygen to a level that allows for the binder, porogen and other organic material to burnout or the formation of the sintered (ceramic) body. The burnout phase of the schedule is conducted in the presence of about 20% or less oxygen, more preferably about 10% or less oxygen, most preferably about 5% or less oxygen.

During the initial stages of the debindering (porogen oxidation) and calcining schedule (from room temperature up to about 900 C) the porogens should undergo burnout. When a large amount of single porogen is used in order to create high porosity in the final calcined part, the ΔT created due to the heat of combustion generated as that porogen oxidizes maybe greater than 120° C. ΔT is the difference of the temperature from the highest temperature in the ceramic body to the lowest temperature in the ceramic body at any time during the burnout. The core means the central 20% disposed about the central axis in the extrusion direction. Edge means the up to about 20% from the outer surface. The larger the ΔT, the greater the probability the ceramic body will crack due to the thermal stress. The exothermic reaction during burnout impacts the ΔT, which is created by the oxidation of the porogen, and may cause large changes in ΔT. The exothermic oxidation reaction of a single porogen occurs at or near the porogen's peak burnout temperature. The burnout temperature is the temperature at which a porogen undergoes an exothermic reaction and oxidizes leaving pores where it once was. However under exothermic conditions the ceramic body can crack or be weakened due to the thermal stresses created by high ΔT.

When only one porogen is used the porogen undergoes a large exothermic reaction resulting in a ΔT that maybe greater than 120° C. By combining two porogens with different burnout temperatures the exothermic reaction is spread out over a longer period of time, for example about of about 300 minutes or less, more preferably about 270 minutes or less, and most preferably about 240 minutes or less. By spreading out the time over which the exothermic reaction occurs, the energy generated from the reaction is also spread out over that time and as a result the ΔT is preferably about 120° C. or less, more preferably about 100° C. or less, and most preferably about 70° C. or less. When calcining is conducted at a ΔT less than about 100° C., the rate of cracking in ceramic bodies is decreased by 80% or more, more preferably by 85% or more, most preferably by 90% or more. The decrease in cracked ceramic bodies allows for an increased number of ceramic bodies available for use. Of the ceramic material that began calcining the overall product yield is greater than 90%, more preferably the product yield is greater than 95%, most preferably the product yield is greater than 98%.

In one embodiment of the invention one may choose to move the ceramic body to a reactor following calcining to allow the ceramic body to form an acicular mullite composition. The ceramic body may be heated under an atmosphere having fluorine containing gas that is separately provided and a temperature sufficient to form the mullite composition. “Separately provided” means that the fluorine containing gas is supplied not from the precursors in the mixture (for example, SiF₄), but from an external gas source pumped into the furnace heating the mixture. Sufficient SiF₄ is added to provide enough fluorine for complete conversion of the Si and Al in the reactor to fluorotopaz.

In another embodiment of the invention the ceramic body maybe formed into a ceramic part such as cordierite. To form cordierite, the above process is followed through the burnout phase with the required Al:Si:Mg to produce cordierite material. Following the burnout phase the sintered (ceramic) body is then heated to a higher temperature then when only forming a ceramic body. The heat is raised to a temperature of at least 1350° C. to at most 1450° C. (about 1410° C.), so as to form cordierite.

### EXAMPLES

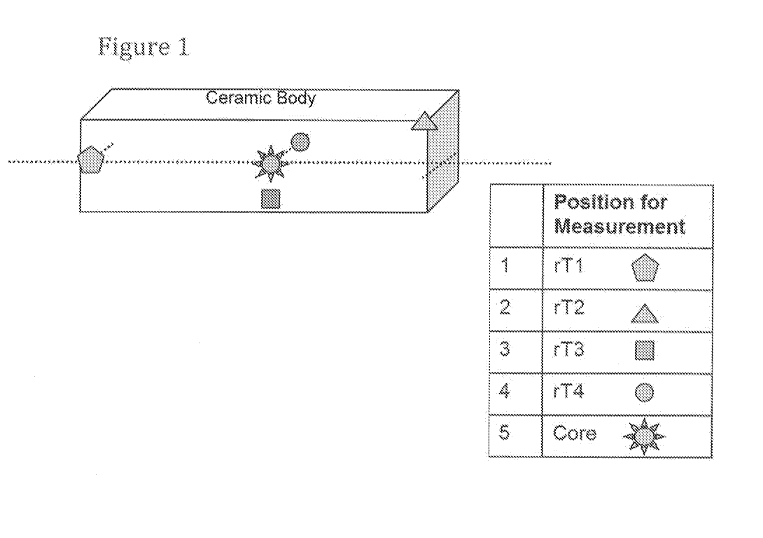

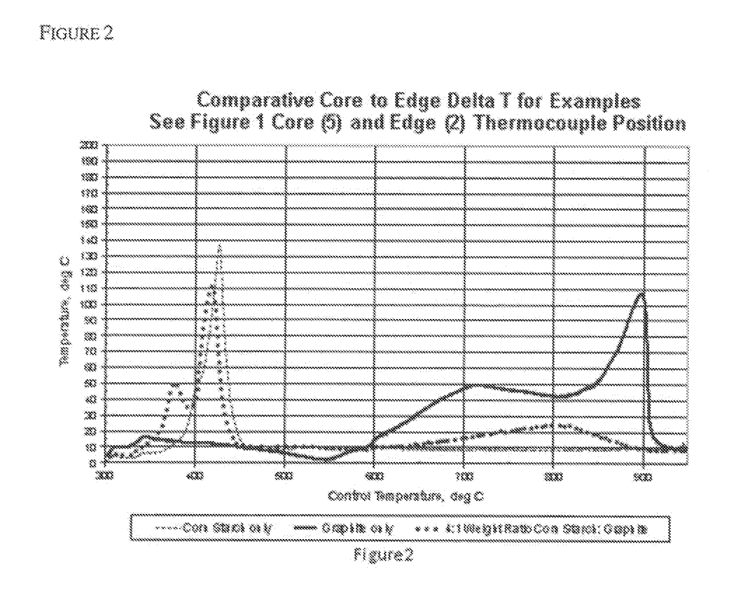

Ceramic bodies are prepared using the formulations contained in Table 1 and dried to remove all the water (100% dry). In the case of comparative example 2 a very slow drying is performed in a dry air oven over several weeks since the graphite level is above the percolation threshold and microwave drying was not possible. Comparative example 1 and the inventive example 3 are dried in a microwave oven. Ceramic bodies are prepared with three different porogen configurations; comparative examples corn starch only, graphite only and an example of the invention a mixture of cornstarch and graphite in a 4:1 ratio. The ceramic bodies are fit with thermocouples as illustrated in FIG. 1, which 1 shows the location of five thermocouples rT1, rT2, rT3, rT4, and rT5. Four relative ΔT measurements are taken from the core of the ceramic material to either: the left face (rΔT1), the upper front right corner (rΔT2), the middle of the bottom (rΔT3), or the middle of the back (rΔT4). The dried ceramic bodies are placed in a kiln and the temperature is raised at a rate of 0.5 to 2.2° C. per minute. The temperature for each thermocouple is monitored. The difference in temperature from the core rT5 to the edge rT2 is Δ T graphed for each example and the graph is shown in FIG. 2. Each mixture contains 40 parts by weight of a porogen.

TABLE 1

| | Example of | | |
|---|---|---|---|
| | Invention | Compar- | Compar- |
| | Mixed Corn- | ative 1 | ative 2 |
| | starch/Graphite | Cornstarch | Graphite |
| RM | (Parts) | (Parts) | (Parts) |
| Mixture of Clay/Alumina¹ | 100.00 | 100.00 | 100.00 |
| Methyl Cellulose | 6.30 | 6.30 | 4.00 |
| Graphite Particles | 8.00 | | 40.00 |
| Cornstarch | 32.00 | 40.00 | |
| Rheology Modifiers | 4.5 | 4.5 | 3.2 |
| Mixture of Water & Glycols | 64.82 | 64.82 | 61.7 |
| Isoelectric Modifiers | 0.36 | 0.36 | 0.36 |

¹Kappa Alumina and silica clay in a Al:Si ration of 3:1.

The preferred embodiment of the present invention has been disclosed. A person of ordinary skill in the art would realize however, that certain modifications would come within the teachings of this invention. Therefore, the following claims should be studied to determine the true scope and content of the invention.

Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Parts by weight as used herein refers to compositions containing 100 parts by weight. The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A process comprising: contacting a mixture of two or more porogens with a mixture used to prepare a ceramic body; wherein one of the porogens has a significantly different chemical property from at least one of the other porogens; drying the mixture; and debindering the mixture.

2. The process of claim 1 where at least one of the porogens has a hydrophobic character and at least one of the other porogens has a hydrophilic character.

3. The process of claim 1 where at least one of the porogens has a significantly different burnout temperature than that of at least one of the other porogens.

4. The process claim 1 where the mixture of two or more porogens lengthens the time period for an exothermic reaction during the debindering process.

5. The process of claim 1 where the mixture of two or more porogens reduces a ΔT at anytime to below 120° C.

6. The process of claim 1 where the mixture of two or more porogens comprises graphite and cornstarch.

7. The process of claim 1 wherein the ratio of cornstarch to graphite is about 6:1 to about 1:1.

8. The process of claim 1 where the mixture is exposed to a drying process, and a reduction in cracking of the ceramic bodies results.

9. The process of claim 1 wherein calcining is performed in the presence of oxygen without the need to slowly increase the temperature process over an extended period of time.

10. The process of claim 1 wherein after calcining the ceramic body is converted to acicular mullite.

11. The process of claim 1 where at least one of the porogens has an organic carbon product and at least one of the other porogensis a HTB carbon.
